(19) United States
(12) Patent Application Publication
(10) Pub. No.: US 2026/0268450 A1
(43) Pub. Date: Sep. 10, 2026

(54) POST-PROCESSING OF RENDERED IMAGES USING A NEURAL PROCESSING UNIT

(71) Applicant: QUALCOMM Incorporated, San Diego, CA (US)

(72) Inventors: Sanjeevi S, Bangalore (IN); Nawneet KUMAR, Bangalore (IN); Vignesh BASKARAN, Bangalore (IN)

(21) Appl. No.: 19/074,036

(22) Filed: Mar. 7, 2025

(51) Int. Cl. G06T 5/60; G06T 5/70; G06T 5/73

(52) U.S. Cl. CPC G06T 5/60; G06T 5/70; G06T 5/73

(57) ABSTRACT

Aspects of the disclosure are directed to post-processing of at least one rendered image. In accordance with one aspect, the disclosure includes rendering a graphics processing unit (GPU) input frame to generate a rendered image frame at a specified frame rate; offloading the rendered image frame to a neural processing unit (NPU) at the specified frame rate; and post-processing the rendered image frame to generate a post-processed image frame.

### TECHNICAL FIELD

This disclosure relates generally to the field of information processing systems, and, in particular, to image post-processing using a neural processing unit (NPU) for a system on a chip (SOC) within an information processing system.

### BACKGROUND

Information processing systems may include a plurality of processing engines, processors or processing cores for a variety of user applications. An information processing system may include a central processing unit (CPU), a graphics processing unit (GPU), a digital signal processor (DSP), an image signal processor (ISP), a neural processing unit (NPU), etc., along with input/output interfaces, a hierarchy of memory units and associated interconnection databuses. In one example, the information processing system may be implemented using one or more system on a chip (SOC) or integrated circuits (IC) wherein each SOC hosts a plurality of processing engines within a single chip. In certain scenarios, image rending tasks performed by the GPU may need to be augmented with post-processing tasks performed by a different processing engine.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides post-processing of at least one rendered image. Accordingly, the present disclosure discloses a method including: rendering a graphics processing unit (GPU) input frame to generate a rendered image frame at a specified frame rate; offloading the rendered image frame to a neural processing unit (NPU) at the specified frame rate; and post-processing the rendered image frame to generate a post-processed image frame.

Another aspect of the disclosure provides an apparatus including: a graphics processing unit (GPU) configured to generate a rendered image frame at a specified frame rate; and a neural processing unit (NPU) coupled to the GPU, the NPU configured to generate a post-processed image frame from the rendered image frame.

Another aspect of the disclosure provides a non-transitory computer-readable medium storing computer executable code, operable on a device including at least one processor and at least one memory coupled to the at least one processor, wherein the at least one processor is configured to implement post-processing of at least one rendered image, the computer executable code including: instructions for causing a computer to render a graphics processing unit (GPU) input frame to generate a rendered image frame at a specified frame rate; instructions for causing the computer to offload the rendered image frame at the specified frame rate; and instructions for causing a neural processing unit (NPU) to post-process the rendered image frame to generate a post-processed image frame.

These and other aspects of the present disclosure will become more fully understood upon a review of the detailed description which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example of a first image post-processing architecture.

FIG. 3 illustrates an example of a second image post-processing architecture.

FIG. 4 illustrates an example of a first application programming interface (API).

FIG. 5 illustrates an example of a second application programming interface (API).

FIG. 6 illustrates an example of an image post-processing timeline diagram.

FIG. 7 illustrates an example flow diagram for implementing post-processing of at least one rendered image.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), uses multiple levels of coordination or synchronization. In one example, a slice may include a processing engine (i.e., a subset of the computing system) as well as associated memory units and other peripheral devices. In one example, execution of an application may be decomposed into a workload which is executed by multiple slices or multiple processing engines.

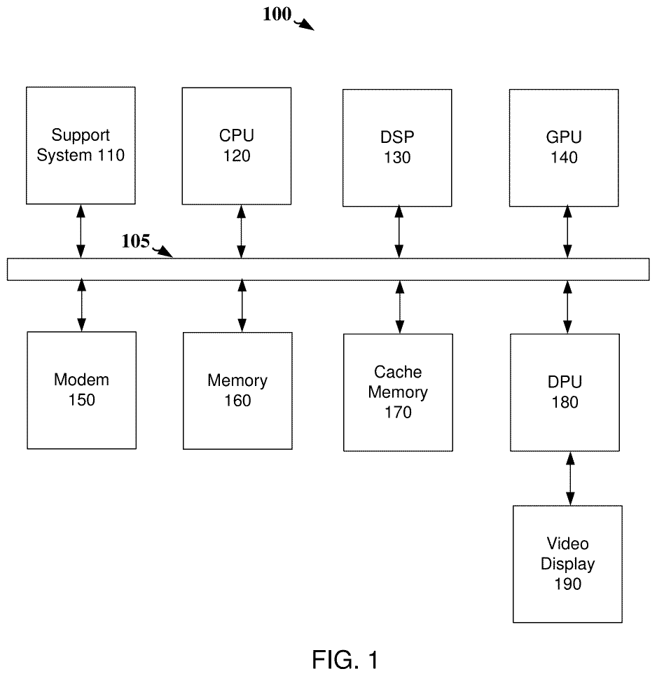

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another. In one example, the information processing system 100 includes a neural processing unit (NPU). For example, the NPU is a processing engine optimized for neural network processing tasks which feature high parallelism and lower numerical precision requirements.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SOC). In one example, the SOC may include the central processing unit (CPU) 120 and other processing engines such as the DSP 130 or the GPU 140. The SOC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, machine learning (ML)/artificial intelligence (AI) applications are included in many products, including gaming applications, multimedia applications and graphics displays. In one example, ML/AI applications may utilize the computational resources of certain processing engines, such as a GPU, for image rendering. For example, image rendering generates a two-dimensional (2D) digital image from an input graphics model or data.

Subsequent to image rendering, the 2D digital image may be subject to additional processing steps, known as post-processing, for further image manipulation. In one example, post-processing may be performed by the GPU. However, to reduce the processing burden on the GPU, post-processing operations may need to be constrained to satisfy image display timing requirements. That is, the image display may need to be updated at a specified frame rate (e.g., measured in frames per second, fps). In one example, the specified frame rate is inputted by a user or is based on an application.

Existing GPU performance may limit the scope of post-processing operations (i.e., only lightweight post-processing may be performed by the GPU). Thus, there is a motivation to offload post-processing of the 2D digital image to another processing engine, rather than the GPU. In one example, the neural processing unit (NPU) may be a suitable processing engine for digital image post-processing operations. For example, usage of the NPU may allow more complex post-processing operations on the digital image while satisfying image display timing requirements.

In one example, contemporary user applications may use a GPU for all image rendering tasks to generate a digital image. In one example, if post-processing of the digital image is required, current practice may be to execute post-processing operations in a shader application and to issue a draw/dispatch operation in every image frame prior to presenting each image frame for execution in the GPU. For example, post-processing operations may include anti-aliasing, motion blur, sharpness, depth of field, blooming (e.g., diffractive effects or sensor saturation), other image enhancement tasks, etc. In one example, usage of the GPU for post-processing operations may restrict applications to lightweight shaders or other operations which consume less GPU resources. Otherwise, unconstrained post-processing operations on the GPU for complex ML/AI-based applications may result in excessive processing burden on the GPU timeline which results in a lower image frame rate (measured in frames per second). Consequently, GPU limitations may restrict application of suitable ML/AI-based applications due to its processing complexity. Thus, augmentation of the GPU with an NPU for ML/AI-based operations is needed.

In one example, contemporary user applications may use a GPU for all image rendering tasks to generate a digital image. In one example, if post-processing of the digital image is required, current practice may be to execute post-processing operations in a shader application and to issue a draw/dispatch operation in every image frame prior to presenting each image frame for execution in the GPU. For example, post-processing operations may include anti-aliasing, motion blur, sharpness, depth of field, blooming (e.g., diffractive effects or sensor saturation), other image enhancement tasks, etc. In one example, usage of the GPU for post-processing operations may restrict applications to lightweight shaders or other operations which consume less GPU resources. Otherwise, unconstrained post-processing operations on the GPU for complex ML/AI-based applications may result in excessive processing burden on the GPU timeline which results in a lower image frame rate (measured in frames per second). Consequently, GPU limitations may restrict application of suitable ML/AI-based applications due to its processing complexity. Thus, augmentation of the GPU with an NPU for ML/AI-based operations is needed.

In one example, a neural processing unit (NPU) is optimized for ML/AI-based applications. For example, the NPU may be optimized for high throughput, lower precision arithmetic and neural network structures. For example, the NPU may be designed expressly for machine learning algorithms and neural network computations used in ML/AI-based applications.

In one example, ML/AI-based applications may be accessed through an application programming interface (API) which integrates ML/AI-based post-processing models to run on the NPU. For example, the models which execute on the NPU ingest a final rendered digital image (e.g., frame buffer) from the GPU and produce a post-processed digital image to an image display. In one example, the NPU executes ML/AI-based post-processing models to yield the post-processed digital image.

In one example, while the NPU executes the post-processing, the GPU is free to execute image rendering of the next image frame in parallel. For example, frame presentation occurs only after the post-processing executes on the NPU which is very rapid and does not add frame time overhead.

In one example, the API is exposed to an application developer to integrate an NPU post-processing model on the final rendered image prior to calling a present API call. In one example, a GPU driver utility intercepts a runtime call to redirect the NPU call to NPU hardware.

In one example, incorporation of ML/AI-based post-processing models to a user application may result in a more realistic output digital image. For example, the models may be used to provide more realistic image effects such as anti-aliasing, motion blur, sharpness, depth of field, blooming, other image enhancement tasks, etc.

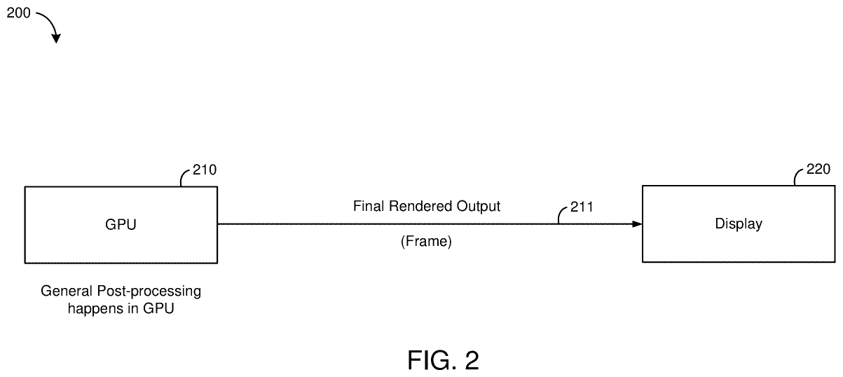

FIG. 2 illustrates an example of a first image post-processing architecture 200. In one example, the first image post-processing architecture 200 includes a graphics processing unit (GPU) 210 and a display unit 220. In one example, the GPU 210 performs image rendering operations as well as general post-processing operations. For example, the GPU 210 may deliver a final rendered image frame 211 to the display unit 220 for display at a given frame rate.

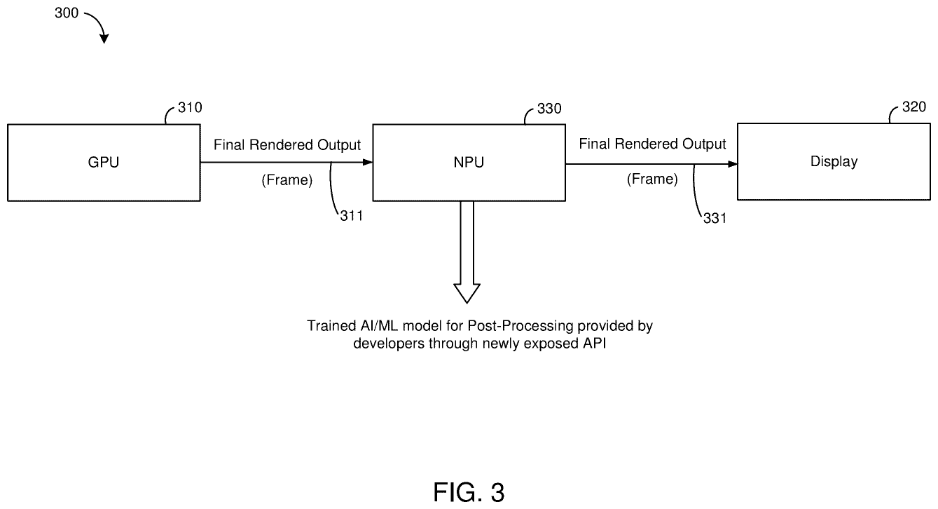

FIG. 3 illustrates an example of a second image post-processing architecture 300. In one example, the second image post-processing architecture 300 includes a GPU 310, a display unit 320 and a neural processing unit (NPU) 330. In one example, the GPU 310 performs image rendering operations and delivers a final rendered image frame 311 to the NPU 330. In one example, the NPU 330 incorporates an ML/AI-based post-processing model which is delivered through an API from a developer. In one example, the NPU 330 delivers a final post-processed image frame 331 to the display unit 320 for display at a given frame rate.

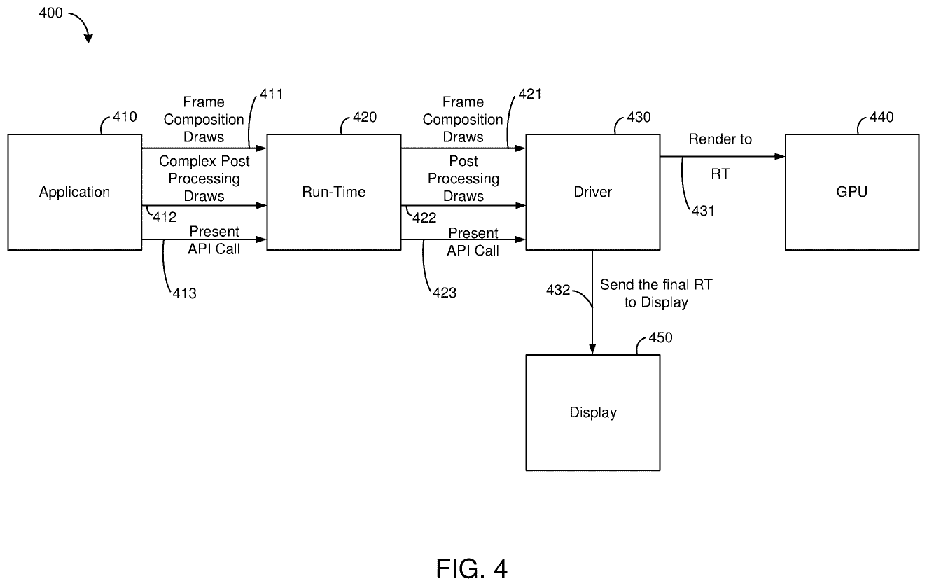

FIG. 4 illustrates an example of a first application programming interface (API) 400. In one example, the first API 400 includes an application 410, a run-time interface module 420, a driver module 430, a GPU 440 and a display unit 450. In one example, the application 410 supplies frame composition draws 411, complex post-processing draws 412 and present API 413 to the run-time interface module 420. In one example, the present API 413 call is used to send a rendered image frame to the display unit 450.

In one example, the run-time interface module 420 provides frame composition draws 421, post-processing draws 422 and present API 423 to the driver module 430. In one example, the driver module 430 sends a rendered image 431 to the GPU 440. In one example, the driver module 430 sends a final rendered image 432 to the display unit 450.

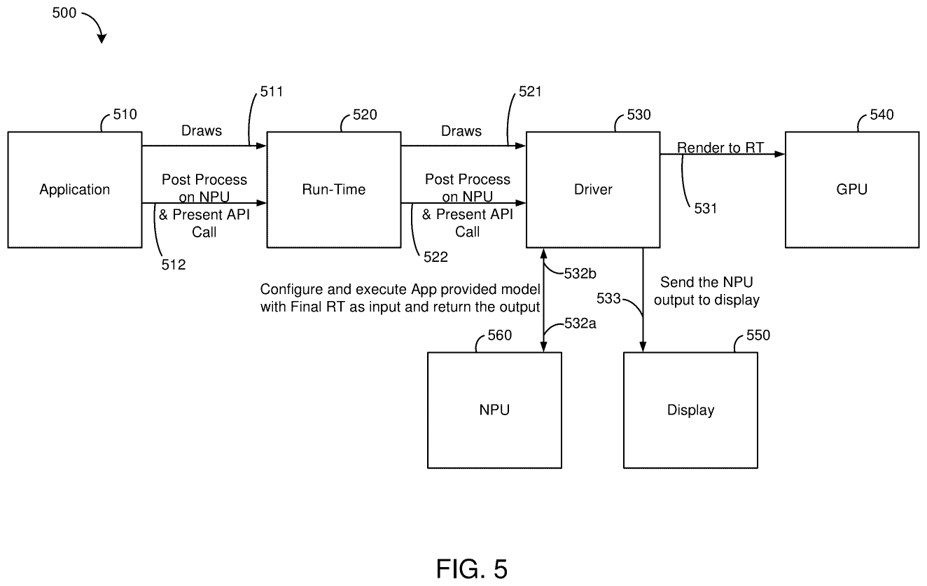

FIG. 5 illustrates an example of a second application programming interface (API) 500. In one example, the second API 500 includes an application 510, a run-time interface module 520, a driver module 530, a GPU 540, an NPU 560 and a display unit 550. In one example, the application 510 supplies frame composition draws 511 and a post-processing model 512 to the run-time interface module 520. In one example, the run-time interface module 520 provides frame composition draws 521 and a post-processing model 522 to the driver module 530. In one example, the driver module 530 sends a rendered image 531 to the GPU 540. In one example, the driver module 530 sends a final rendered image 532a to the NPU 560. And, in one example, the NPU sends the post-processed final rendered image 532b back to the driver module 530. In one example, the driver module sends the NPU output to the display unit 550.

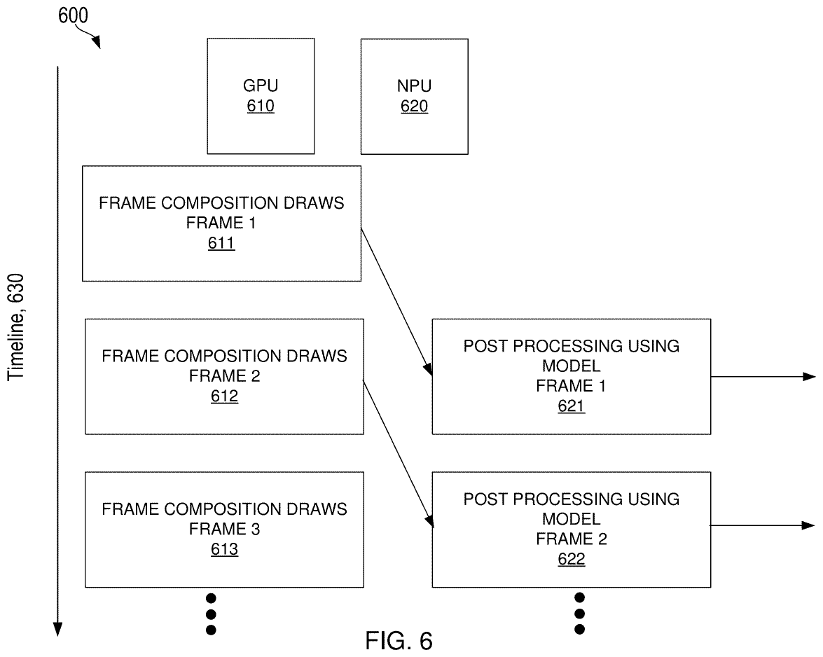

FIG. 6 illustrates an example of an image post-processing timeline diagram 600. In one example, the timeline diagram 600 shows a GPU 610 and a NPU 620 which executes a plurality of tasks on a timeline 630. In one example, a first task of the plurality of tasks is a frame composition draw of a first frame 611 by the GPU 610. In one example, a second task of the plurality of tasks is a frame composition draw of a second frame 612 by the GPU 610. In one example, a third task of the plurality of tasks is a frame composition draw of a third frame 613 by the GPU 610. In one example, a fourth task of the plurality of tasks is a model-based post-processing of the first frame 621 by the NPU 620. In one example, a fifth task of the plurality of tasks is a model-based post-processing of the second frame 622 by the NPU 620. In one example, the GPU 610 and NPU 620 operate in parallel where the GPU 610 operates on a current frame while the NPU 620 operates on a previous frame. That is, the GPU 610 and the NPU 620 operate concurrently on adjacent frames.

In one example, a post-processing task may employ an ML/AI-based post-processing model on an image. For example, the model may be used to enhance image quality, provide anti-aliasing features or provide image realism. For example, the model may be used to enhance lighting and shadows in the image. For example, the model may be used to enhance sharpness or depth of field in the image. For example, the model may be used for upscaling of the image (e.g., resizing the image).

In one example, image post-processing may be a feature exposed to application software using an application programming interface (API). For example, application software developers may train their post-processing models using local computing resources depending on their application needs. In one example, an ML/AI-based post-processing model may be transferred through the API and executed on the NPU.

In one example, a final rendered image output of a GPU is an input to the NPU. In one example, a post-processed image frame is an output of the NPU and is delivered to a display unit. In one example, the application software developer provides the ML/AI-based post-processing model through the API and a driver module invokes the NPU to execute the post-processing model. For example, the post-processing model is executed by the NPU concurrently while the GPU renders the next image frame.

In one example, ML/AI-based post-processing in the GPU may be challenging due to model complexity and processing timeline constraints. Consequently, the API may be used by the application software developer to incorporate complex ML/AI-based post-processing which is executed in the NPU in a parallel manner. In one example, a graphics driver invokes the NPU, manages data transfer from the GPU to the NPU and delivers the post-processed image frame to the display unit. In one example, parallel usage of the NPU for ML/AI-based post-processing of rendered image frames allows image enhancement without compromising computational performance.

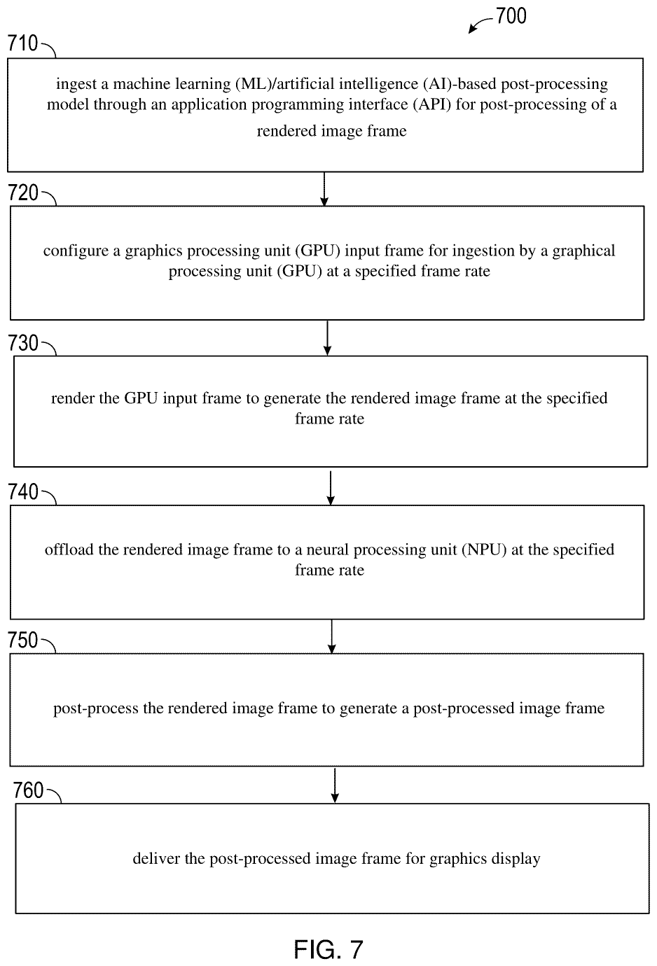

FIG. 7 illustrates an example flow diagram 700 for implementing post-processing of at least one rendered image. In block 710, ingest a machine learning (ML)/artificial intelligence (AI)-based post-processing model through an application programming interface (API) for post-processing of a rendered image frame. That is, in one example, a machine learning (ML)/artificial intelligence (AI)-based post-processing model is ingest through an application programming interface (API) for post-processing of a rendered image frame. In one example, the step of block 710 is performed by a graphics processing unit (GPU).

In block 720, configure a graphics processing unit (GPU) input frame for ingestion by a graphical processing unit (GPU) at a specified frame rate. That is, in one example, a graphics processing unit (GPU) input frame is configured for ingestion by a graphical processing unit (GPU) at a specified frame rate. In one example, the GPU input frame defines an image frame format with a plurality of pixels per image line and a plurality of image lines per image frame. In one example, the GPU input frame defines an image frame pixel depth. In one example, the image frame pixel depth includes a plurality of chromatic components. In one example, the step of block 720 is performed by a controller.

In block 730, render the GPU input frame to generate the rendered image frame at the specified frame rate. That is, in one example, the GPU input frame is rendered to generate the rendered image frame at the specified frame rate. In one example, the rendered image frame includes a two-dimensional (2D) array of pixels with the plurality of pixels per image line and the plurality of image lines per image frame. In one example, render means to generate. In one example, the step of block 730 is performed by a graphics processing unit (GPU).

In block 740, offload the rendered image frame to a neural processing unit (NPU) at the specified frame rate. That is, in one example, the rendered image frame is offloaded to a neural processing unit (NPU) at the specified frame rate. In one example, the offloading is performed synchronously with a frame rate trigger signal. In one example, the step of block 740 is performed by a graphics processing unit (GPU).

In block 750, post-process the rendered image frame to generate a post-processed image frame. That is, in one example, the rendered image frame is post-processed to generate a post-processed image frame. In one example, the post-processed image frame is generated while a subsequent rendered image frame is being generated. In one example, the step of block 750 is performed by a neural processing unit (NPU).

In block 760, deliver the post-processed image frame for graphics display. That is, in one example, the post-processed image frame is delivered to a display unit for graphics display. In one example, the graphics display is implemented with a graphics display unit. In one example, the step of block 760 is performed by a neural processing unit (NPU).

In one example, the present disclosure includes a method including: rendering a graphics processing unit (GPU) input frame to generate a rendered image frame at a specified frame rate; offloading the rendered image frame to a neural processing unit (NPU) at the specified frame rate; and post-processing the rendered image frame to generate a post-processed image frame.

In one example, the rendered image frame includes a two-dimensional (2D) array of pixels with a plurality of pixels per image line and a plurality of image lines per image frame. In one example, the offloading is performed synchronously with a frame rate trigger signal. In one example, the post-processed image frame is generated while a subsequent rendered image frame is being generated.

In one example, the method further includes delivering the post-processed image frame for graphics display. In one example, the method further includes configuring the graphics processing unit (GPU) input frame for ingestion by a graphical processing unit (GPU) at the specified frame rate.

In one example, the GPU input frame defines an image frame format with a plurality of pixels per image line and a plurality of image lines per image frame. In one example, the GPU input frame defines an image frame pixel depth. In one example, the image frame pixel depth includes a plurality of chromatic components. In one example, the method further includes ingesting a machine learning (ML)/artificial intelligence (AI)-based post-processing model through an application programming interface (API) for post-processing of the rendered image frame.

In one example, the present disclosure includes an apparatus including: a graphics processing unit (GPU) configured to generate a rendered image frame at a specified frame rate; and a neural processing unit (NPU) coupled to the GPU, the NPU configured to generate a post-processed image frame from the rendered image frame.

In one example, the post-processed image frame may include one or more of the following: an anti-aliasing feature, a motion blur feature, a sharpness feature, a depth of field feature, or a diffractive effect feature. In one example, the apparatus further includes a controller coupled to the NPU, the controller configured to set a graphics processing unit (GPU) input frame for ingestion by the GPU at the specified frame rate. In one example, the rendered image frame includes a two-dimensional (2D) array of pixels with a plurality of pixels per image line and a plurality of image lines per image frame. In one example, the apparatus further includes a display unit coupled to the NPU, the display unit configured to display the post-processed image frame. In one example, the display unit is connected to the NPU via a driver module. In one example, the GPU input frame defines an image frame format with a plurality of pixels per image line and a plurality of image lines per image frame.

In one example, the present disclosure includes a non-transitory computer-readable medium storing computer executable code, operable on a device including at least one processor and at least one memory coupled to the at least one processor, wherein the at least one processor is configured to implement post-processing of at least one rendered image, the computer executable code including: instructions for causing a computer to render a graphics processing unit (GPU) input frame to generate a rendered image frame at a specified frame rate; instructions for causing the computer to offload the rendered image frame at the specified frame rate; and instructions for causing a neural processing unit (NPU) to post-process the rendered image frame to generate a post-processed image frame.

In one example, the non-transitory computer-readable medium further includes instructions for causing the computer to configure the GPU input frame for ingestion at the specified frame rate. In one example, the non-transitory computer-readable medium further includes instructions for causing the NPU to ingest a machine learning (ML)/artificial intelligence (AI)-based post-processing model through an application programming interface (API) for post-processing of the rendered image frame. In one example, the rendered image frame includes a two-dimensional (2D) array of pixels with a plurality of pixels per image line and a plurality of image lines per image frame.

In one aspect, one or more of the steps for providing post-processing of at least one rendered image in FIG. 7 may be executed by one or more processors which may include hardware, software, firmware, etc. The one or more processors, for example, may be used to execute software or firmware needed to perform the steps in the flow diagram of FIG. 7. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
rendering a graphics processing unit (GPU) input frame to generate a rendered image frame at a specified frame rate;
offloading the rendered image frame to a neural processing unit (NPU) at the specified frame rate; and
post-processing the rendered image frame to generate a post-processed image frame.

2. The method of claim 1, wherein the rendered image frame includes a two-dimensional (2D) array of pixels with a plurality of pixels per image line and a plurality of image lines per image frame.

3. The method of claim 1, wherein the offloading is performed synchronously with a frame rate trigger signal.

4. The method of claim 1, wherein the post-processed image frame is generated while a subsequent rendered image frame is being generated.

5. The method of claim 1, further comprising delivering the post-processed image frame for graphics display.

6. The method of claim 5, further comprising configuring the graphics processing unit (GPU) input frame for ingestion by a graphical processing unit (GPU) at the specified frame rate.

7. The method of claim 6, wherein the GPU input frame defines an image frame format with a plurality of pixels per image line and a plurality of image lines per image frame.

8. The method of claim 6, wherein the GPU input frame defines an image frame pixel depth.

9. The method of claim 8, wherein the image frame pixel depth includes a plurality of chromatic components.

10. The method of claim 6, further comprising ingesting a machine learning (ML)/artificial intelligence (AI)-based post-processing model through an application programming interface (API) for post-processing of the rendered image frame.

11. An apparatus comprising:
a graphics processing unit (GPU) configured to generate a rendered image frame at a specified frame rate; and
a neural processing unit (NPU) coupled to the GPU, the NPU configured to generate a post-processed image frame from the rendered image frame.

12. The apparatus of claim 11, wherein the post-processed image frame may include one or more of the following: an anti-aliasing feature, a motion blur feature, a sharpness feature, a depth of field feature, or a diffractive effect feature.

13. The apparatus of claim 11, further comprising a controller coupled to the NPU, the controller configured to set a graphics processing unit (GPU) input frame for ingestion by the GPU at the specified frame rate.

14. The apparatus of claim 13, wherein the rendered image frame includes a two-dimensional (2D) array of pixels with a plurality of pixels per image line and a plurality of image lines per image frame.

15. The apparatus of claim 13, further comprising a display unit coupled to the NPU, the display unit configured to display the post-processed image frame.

16. The apparatus of claim 13, wherein the GPU input frame defines an image frame format with a plurality of pixels per image line and a plurality of image lines per image frame.

17. A non-transitory computer-readable medium storing computer executable code, operable on a device comprising at least one processor and at least one memory coupled to the at least one processor, wherein the at least one processor is configured to implement post-processing of at least one rendered image, the computer executable code comprising:
instructions for causing a computer to render a graphics processing unit (GPU) input frame to generate a rendered image frame at a specified frame rate;
instructions for causing the computer to offload the rendered image frame at the specified frame rate; and
instructions for causing a neural processing unit (NPU) to post-process the rendered image frame to generate a post-processed image frame.

18. The non-transitory computer-readable medium of claim 17, further comprising instructions for causing the computer to configure the GPU input frame for ingestion at the specified frame rate.

19. The non-transitory computer-readable medium of claim 18, further comprising instructions for causing the NPU to ingest a machine learning (ML)/artificial intelligence (AI)-based post-processing model through an application programming interface (API) for post-processing of the rendered image frame.

20. The non-transitory computer-readable medium of claim 19, wherein the rendered image frame includes a two-dimensional (2D) array of pixels with a plurality of pixels per image line and a plurality of image lines per image frame.
